(19) United States
(12) Patent Application Publication
(10) Pub. No.: US 2019/0077293 A1
(43) Pub. Date: Mar. 14, 2019

(54) OVERFILL PREVENTION SYSTEM PROBE FOR TANKS FOR TRANSPORT OF LIQUID FUELS AND CORRESPONDING OVERFILL PREVENTION SYSTEM

(71) Applicant: INTERSENS, Paris (FR)

(72) Inventor: Bruno Morel-Fatio, Paris (FR)

(73) Assignee: INTERSENS, Paris (FR)

(21) Appl. No.: 16/129,557

(22) Filed: Sep. 12, 2018

(30) Foreign Application Priority Data
Sep. 13, 2017 (FR) 1758479

(51) Int. Cl. B60P 3/22; B67D 7/32

(52) U.S. Cl. CPC B60P 3/228; B60P 3/2245; B67D 7/3218; B60P 3/225

(57) ABSTRACT

This overfill prevention system probe for tanks for transport of liquid fuels comprises a level detector mounted on a support that is fixed on the tank so that the detector is placed in the tank at a maximum permissible filling height. The level detector includes a measuring sensor capable of providing a redundant level measurement.

### BACKGROUND

Worldwide, the great majority of such systems must meet CEN European standard EN 13922, which ensures in particular interoperability between the probes of the tank vehicle and the loading device. To prevent explosive hazardous substances from overflowing during the filling phase, a probe is placed in the upper part of each compartment of the tank vehicle. The status of the probe changes when it gets wet. It is connected to the loading device so that it immediately stops the filling process when wetting is detected.

In order to limit filling, the use of probes based on the implementation of a thermistor that detects a temperature differential when the probe comes into contact with the product was initially proposed.

However, it was noted that this type of thermistor-based technology was too fragile and led to excessively frequent replacements of the probes.

Detection of the fuel level in a tank, during the filling thereof, using probes based on an optical principle of variation of the refraction angle of a light beam, has also been proposed. These probes use a cone made from transparent material, for example polypropylene, which reflects a non-divergent light beam emitted by a light-emitting diode, and including a receiver that detects the reflected light. The cone is positioned at an overflow detection level. Thus, when the liquid level reaches the detection level of the probe, the refractive index of the cone is changed and the light is no longer detected.

There are however many drawbacks to this type of technology.

Firstly, the angle of refraction of the light beam depends on a very small contact surface, which receives the light beam, in the order of 1 mm in diameter. If, for example, a bubble is present at this point of contact, the direction of the beam is disrupted.

Secondly, the light beam can be reflected uncontrollably by metal surfaces within the tank. For example, light beam scattering devices recently had to be added at the bottom of fraud protection sheaths to prevent undesirable reflections on these sheaths.

It was also noted that the optical characteristics of the transparent cone tend to deteriorate over time, for example by opacification or the appearance of micro cracks, so that over time the function of the transparent cone tends to deteriorate.

In addition, the light energy of the light-emitting diodes decreases over time and when the temperature increases. This phenomenon is well known to optical probe manufacturers. When the temperature exceeds 60° C., satisfactory operation is no longer guaranteed and the life of the product is shortened.

Finally, the energy required by a light-emitting diode to emit a light beam is intrinsically high, and is hardly compatible with the “intrinsic safety” constraints required in explosive atmospheres that limit electrical energy to extremely low levels to ensure the absence of sparks and hot spots. Sufficient light intensity is difficult to achieve, particularly when the performance of the diodes has deteriorated.

### SUMMARY

The aim of the disclosure is to propose an overfill prevention system probe for tanks for transport of liquid fuels that overcomes these various drawbacks.

According to a first aspect, the object of the disclosure is therefore an overfill prevention system probe for tanks for transport of liquid fuels, comprising a level detector mounted on a support that is fixed on the tank so that the detector is placed in the tank at a maximum permissible filling height, the level detector including a measuring sensor capable of ensuring redundant level measurement.

According to a second aspect, a further object of the disclosure is an overfill prevention system for tanks for transport of liquid fuels, comprising a probe assembly as defined above, for detecting a filling level in a set of compartments, and a filling controller receiving a filling authorization signal emitted for each probe, to control pump and valve type actuators of a filling controller.

### DESCRIPTION OF THE DRAWINGS

Further aims, features and advantages of the disclosure will become apparent on reading the following description, given as a non-limitative example with reference to the attached drawings, in which:

FIG. 1 is a diagrammatic view of a tank equipped with an overfill prevention system according to the disclosure;

FIG. 2 is a block diagram of an embodiment of a probe according to the disclosure; and

FIG. 3 is a perspective diagrammatic view of an embodiment of a probe according to the disclosure.

### DETAILED DESCRIPTION

The present disclosure relates to the transportation of liquid petroleum fuels, and more particularly relates to overfill prevention systems for tanks for transport of liquid fuels. A particular objective is an overfill prevention system for implementation during the filling of tanks.

According to a first aspect, the object of the disclosure is therefore an overfill prevention system probe for tanks for transport of liquid fuels, comprising a level detector mounted on a support that is fixed on the tank so that the detector is placed in the tank at a maximum permissible filling height, the level detector including a measuring sensor capable of ensuring redundant level measurement.

The probe according to the disclosure thus makes it possible to easily implement a redundancy principle that significantly improves the safety of the measurement made within the probe in physical contact with the product the level of which is being controlled. In addition, the disclosure ensures three-dimensional measurement of the liquid level, and not one-dimensional as is the case when using an optical sensor.

For example, the level detection may be based on a comparison between the dielectric permittivity measurement either of the ambient gas (non-wetted sensor) or of the liquid being filled (wetted sensor).

In one embodiment, the measuring sensor comprises at least two independent measuring assemblies that make it possible to increase the reliability of the device.

In other words, the probe includes several subassemblies of independent sensors delivering measurements which, by correlation, make it possible to increase the safety of the result provided by the probe.

For example, each measuring assembly includes a set of several electrodes and the sensor includes means for measuring the dielectric permittivity of the fluid between the electrodes.

In one embodiment, every measuring assembly includes at least two sets of electrodes embodied by parallel plates separated in pairs and defining different detection zones, separated by a common separating electrode, the dielectric permittivity measuring means being capable of measuring the dielectric permittivity between the plates independently for each detection zone.

Advantageously, the probe includes means for processing signals by correlation of the redundant level measurements from the sensor in order to increase the safety thereof.

According to a second aspect, a further object of the disclosure is an overfill prevention system for tanks for transport of liquid fuels, comprising a probe assembly as defined above, for detecting a filling level in a set of compartments, and a filling controller receiving a filling authorization signal emitted for each probe, to control pump and valve type actuators of a filling controller.

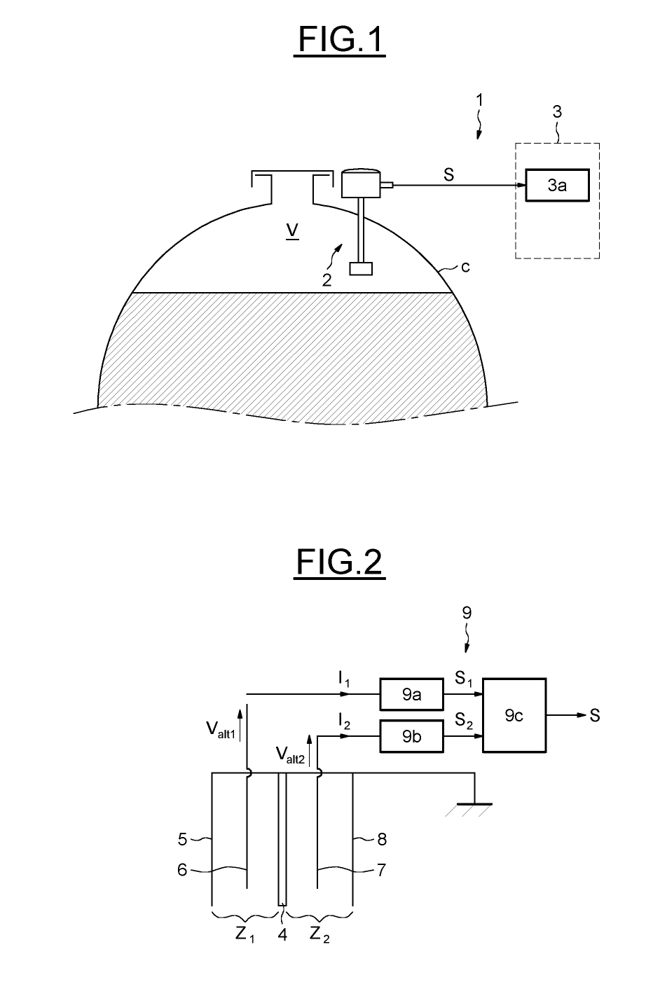

Tank C shown in FIG. 1 is for example a tank of a tank truck type vehicle used for transporting liquid petroleum fuel.

In the embodiment illustrated in FIG. 1, only one tank has been shown. In France, such a truck can have seven to nine compartments of variable size.

As can be seen, each tank C is equipped with an overfill prevention system in order to detect any risk of overflow by detecting the filling of the tank to a maximum permissible filling height that, advantageously, defines a safety stowage volume V, for example in the order of a hundred liters.

Such a stowage volume makes it possible to stop the pumps or valves of a filling system, when the maximum height is reached, in order to prevent any risk of overflow.

The overfill prevention system, denoted by general numerical reference sign 1, includes, for each tank, a probe 2 that detects the maximum filling level in the tank C and is connected to a device 3 for loading tanks for transport of liquid fuels provided at the tank truck loading bay, and comprising a filling controller 3a made up of a probe analyzer incorporated into the loading device for controlling the tank loading device on the basis of the signals from the probes 2.

The probe 2 comprises a level sensor 2a including electrodes and means for measuring the dielectric permittivity of the fluid between the electrodes.

However, the probe 2 visible in FIG. 1 is a multizone probe and therefore ensures independent, redundant impedance measurements.

The probe 2 thus includes several sets of electrodes in the form of independent sets of metal plates, two here, separated by a common separating electrode 4, formed by one of the plates, and delimiting two zones Z1 and Z2. In the embodiment illustrated in FIG. 2, the probe thus includes two redundant level measuring assemblies, each formed by a set of metal plates each associated with means of measuring the dielectric permittivity between the plates. Of course, a larger number of detection zones may be used to increase the number of redundant level measurements.

Each zone Z1 or Z2 contains three metal plates 5, 6 and 4, on one side, and 4, 7 and 8, on the other.

These plates are apart from one another so that volumes of fluid, gas or liquid, can flow between them.

Each fluid has a specific dielectric permittivity relative to a vacuum (εr).

For example, the permittivity of air is 1.0005. The permittivity of oil or petroleum products is greater than 2. The permittivity of alcohol is greater than 6. Finally, the permittivity of water is greater than 30.

The value of the capacitor formed by the facing parallel plates is given by the equation:

C=εr×(S/e)

Where:

S=area of the conducting plates in m²; and

e=distance between the plates in m.

The value of the capacitor formed by each pair of plates is given in farads. Thus, depending on the geometry of the electrodes, an impedance that is the image of the dielectric permittivity of the medium in which the electrodes are located is measured.

The arrangement of the sets of facing electrodes separated by the separating plate 4 makes it possible to create independent groups of measurement capacitors providing measurements that are themselves independent.

The probe 2 comprises a computing device 9 incorporating the independent impedance measuring sensors. It retrieves the real and imaginary parts of the impedances of the fluid present in zones Z1 and Z2 and compares them with threshold values.

As can be seen, the computing device 9 includes two independent central units 9a and 9b each ensuring, in parallel, the processing of the independent impedance measurement signals S1 and S2. These signals are supplied to a comparator 9c that ensures the correlation between the impedance values supplied. It must in particular be checked that the deviation between the impedance values obtained for each zone does not exceed a threshold limit value beyond which the level measurement is regarded as invalid.

When the probe detects the presence of a fluid the dielectric permittivity of which corresponds to that of a liquid and not that of a gas, the computing device 9 updates the level with a filling authorization or prohibition signal S sent to the filling controller 3a.

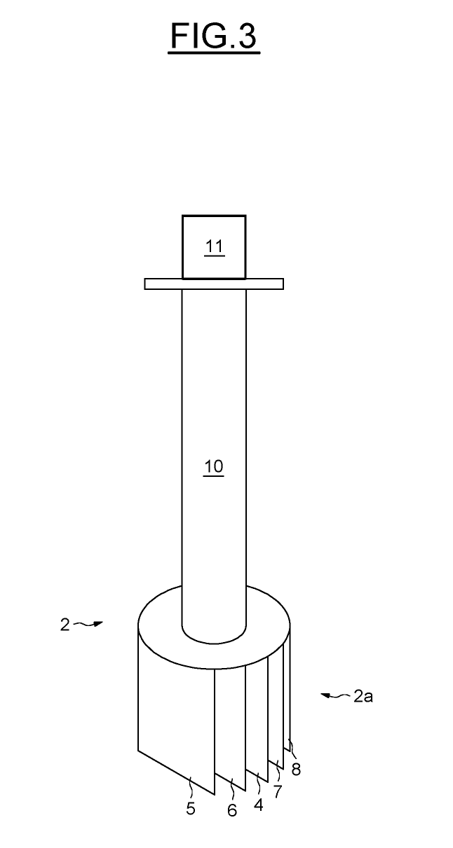

Finally, FIG. 3 is a diagrammatic view of an embodiment of a probe according to the disclosure.

In this figure, the two sets of plates 5, 6, 7 and 8 separated by the separating plate 4 can be seen.

These two sets of plates are mounted on a tubular support 10, itself topped by a head 11 serving as a connecting relay for linking the probe with the filling controller 3a.

For example, the central unit may take the form of an electronic board mounted inside the tube 10.

A cylindrical cover (not shown) that allows the fluid through surrounds the sets of plates to protect them mechanically.

As shown in FIG. 1, the assembly is mounted on the tank, through a hole made in the upper part of wall thereof, so that the detector, and in particular the electrodes, are placed at the maximum permissible filling height.

While illustrative embodiments have been illustrated and described, it will be appreciated that various changes can be made therein without departing from the spirit and scope of the invention.

The embodiments of the invention in which an exclusive property or privilege is claimed are defined as follows:

1. A probe for an overfill prevention system for tanks for transport of liquid fuels, comprising a level detector mounted on a support that is fixed on the tank so that the detector is placed in the tank at a maximum permissible filling height, characterized in that the level detector includes a measuring sensor capable of providing a redundant level measurement, the sensor comprising at least one measuring assembly, each measuring assembly including at least two sets of electrodes separated in pairs and defining detection zones and means for measuring the dielectric permittivity of the fluid between the electrodes, the dielectric permittivity measuring means being capable of measuring the dielectric permittivity between the electrodes independently for each detection zone, and the sets of electrodes being separated by a common separating electrode.

2. The probe according to claim 1, wherein the sensor includes at least two independent measuring assemblies in order to increase the reliability of the device.

3. The probe according to claim 1, comprising means for processing signals by correlation of the redundant level measurements from the measuring sensor in order to increase the safety thereof.

4. An overfill prevention system for tanks for transport of liquid fuels, comprising a probe assembly according to claim 1, for detecting a filling level in a set of compartments, and a filling controller receiving a filling authorization signal emitted for each probe, for controlling pump and valve type actuators of a filling controller.
